(19) United States
(12) Patent Application Publication
(10) Pub. No.: US 2022/0222739 A1
(43) Pub. Date: Jul. 14, 2022

(54) METHOD FOR CREATING EC-INTEGRATED METAMEDIA, DISTRIBUTION SYSTEM, AND DISTRIBUTION METHOD

(71) Applicant: Mission Group Inc., Tokyo (JP)

(72) Inventors: Tom OISHI, Tokyo (JP); Sungsam YOO, Tokyo (JP)

(21) Appl. No.: 17/706,447

(22) Filed: Mar. 28, 2022

Related U.S. Application Data
(63) Continuation of application No. PCT/JP2020/036688, filed on Sep. 28, 2020.

(30) Foreign Application Priority Data
Sep. 30, 2019 (JP) 2019-179892

(51) Int. Cl. G06Q 30/06; G06V 20/40; G11B 27/031; G06F 9/451

(52) U.S. Cl. CPC G06Q 30/0643; G06V 20/41; G06F 9/451; G06Q 30/0623; G11B 27/031

(57) ABSTRACT

According to one embodiment, a method for creating EC-integrated metamedia comprises: registering information on a product in a product data management database; creating an EC product table to manage information related to EC processing of the product; creating an edit information sharing file to share information on editing the video content; creating a scene management file to manage scene information based on information related to scenes in the edit information sharing file and adding thereto a product ID of the product data management database; registering scene data of the scene management file in a scene data management database; registering video data of the video content for the public in a video data management database; and generating trained data for object detection based on scenes in the video data for the public, the scene data in the scene data management database, and the product data in the product data management database.

### CROSS-REFERENCE TO RELATED APPLICATION

This application is a bypass application and claims the benefit of International Application No. PCT/JP2020036688 under 35 U.S.C. § 111(a), which was filed on Sep. 28, 2020 and is based on and claims the benefit of priority from Japanese Patent Application No. 2019-179892, filed on Sep. 30, 2019, the entire contents of each are incorporated herein by reference in their entirety.

### FIELD

Embodiments described herein relate generally to a technology for integrating electronic commerce (e-commerce or EC) with video content, more specifically to a method for creating EC-integrated metamedia with a built-in user interface (UI) function for e-commerce that allows viewers of video content to trade resources for producing the video content, including display materials of the video content, as products, a distribution system, and a distribution method.

Note that, for example, Multimedia & Internet Dictionary (https://www.jiten.com/dicmi/docs/k34/23195.htm, retrieved on Sep. 10, 2019) defines the term “metamedia” as “a concept of integrating established media, such as audio, text, images, and video, to be available to people”; however, the term refers herein to “media that integrates established media such as audio, text, images, and video”.

### BACKGROUND

### First Background Art

The first background art relates to new models (forms, methods, and related technologies) for e-commerce.

An e-commerce model called “live commerce” is becoming popular, where a celebrity or an influencer streams a live video so that viewers can purchase products as they ask questions and make comments in real time.

Live commerce is an online shopping model that blends e-commerce into live video streaming, allowing viewers to purchase products while watching a live video; it can be described as an interactive version of home shopping, where viewers can shop in real time as they ask questions and make comments to the presenter or seller.

An e-commerce model called “drama commerce” has also begun to gain popularity, which delivers an original drama on an e-commerce site over the Internet so that viewers can purchase items that appear in the drama.

Drama commerce can show viewers the texture and silhouette (shape) of a product appearing in a drama (e.g., an item worn or used by a celebrity), which is not available on conventional e-commerce sites that only provide product descriptions, and it is attracting attention as a new approach that can overcome the limitations of e-commerce sites.

Patent Documents 1, 2, and 3 provide a detailed description of the above-mentioned first background art. Patent Document 1 discloses a system and method for providing a user with on-demand access to merchandise information related to a film while the film is being presented and establishing a link between the user and a merchant who is the source of the merchandise information. Patent Document 2 discloses a few types of information equipment, a billing method, and a program to enable users to obtain information related to a video image displayed on a screen. Patent Document 3 discloses a system and method for providing an interactive viewing experience in which viewers of a video program can access information regarding products displayed in the video program.

### Second Background Art

The second background art relates to image recognition AI technology. Specifically, it relates to a technology to apply image recognition through machine learning or deep learning using artificial intelligence (AI) to the field of e-commerce.

There has been a widespread of mechanisms in which when a user uploads a product image taken with a smartphone or the like to the search engine of an e-commerce site, the image is subjected to such processes as category identification, subject recognition, and feature detection using image recognition, and the same or similar products are picked up from product images on the e-commerce site based on information obtained by the image recognition and displayed as recommendations. There have also been video editing systems that allow users to easily create video and image content for e-commerce sites using image recognition functions.

Those mechanisms and systems require technologies related to object detection. In recent years, it has become possible to obtain information including not only data on the types of multiple objects identified in an image (dog, cat, car, etc.) but also data on the location of the objects in the image with high speed and high accuracy through image recognition AI for object detection using deep learning.

Non-Patent Documents 1 and 2 describe the above-mentioned second background art in detail. Recently, some companies have begun to offer advanced technology related to such image recognition AI through a cloud service.

For example, Non-Patent Document 3 describes a service that allows users to add image and video analysis functions to an application using an application program interface (API). The use of this service makes it possible to identify a plurality of objects displayed in an image or video and obtain data about the objects, thereby facilitating the annotation (tagging) of the data about the objects.

### Third Background Art

The third background art relates to audio (acoustic) watermarking technology, and more particularly relates to a technology to embed encrypted text data or the like in an audio signal.

By using audio (acoustic) watermarking technology, it becomes possible to build an application that acquires text data embedded in the sound of the television (TV), radio, advertising signage, or content through the microphone of a smartphone and performs an action based on the text data in real time.

Patent Documents 4 and 5 describe the above-mentioned third background art in detail. Recently, some companies have started to provide such audio (acoustic) watermarking technology through a software development kit (SDK).

For example, Non-Patent Document 4 describes a service that allows users to integrate audio (acoustic) watermarking technology into various applications using an SDK. The use of such a service makes it easy to handle content on a second or double screen in conjunction with broadcast content such as a TV program and TV commercial (second/double screen approach, TV to online to offline (T2020)).

### Fourth Background Art

The fourth background art relates to digital asset management (DAM) technology. Specifically, it relates to a technology for centrally managing digital content, such as text, video, photos, and catalog data, using a platform or the like.

A system using DAM technology provides functions to implement: (1) aggregation of various digital data and addition of metadata thereto to facilitate access to necessary information, (2) data format conversion and data size change according to media to be distributed (website, e-commerce site, catalog, SNS, etc.), (3) management of the expiration date of copyrighted material in association with license data, (4) facilitation of production process by creating a workflow of creative production related to digital content, and the like.

Video content such as films, dramas, cartoons, and music videos require not only funds but also various resources: human resources such as investors (individual or corporation), directors, original authors, screenwriters, casting directors, actors, voice actors, music producers, performers, interpreters, translators, film crew, editorial staff, lighting crew, set designers, costume designers, stylists, hair designers, makeup artists, action choreographers, stunt doubles, and extras; spaces such as a filming location or studio where scenes are filmed; props such as animals, vehicles, costumes, ornaments, and interior goods; equipment such as cameras and lights; technology resources and tools used for computer graphics, recording, and editing, and the like. For example, in the production of video content, if DAM technology is used to aggregate information on these resources and add metadata thereto, it becomes easy to access necessary information, convert the data format, and change the data size, which makes it possible to automatically build UI functions according to an e-commerce model.

Information about the above-mentioned fourth background art can be found in many places on the Internet. For example, Non-Patent Document 5 describes functions related to browser-based file management, video management, video scene management and search, copyright information management, download control, and usage application workflow.

The contents of all the prior art documents cited above are incorporated herein by reference.

### PRIOR ART DOCUMENT

### Patent Document

Patent Document 1: Japanese Unexamined Patent Publication No. H8-287107
Patent Document 2: Japanese Unexamined Patent Publication No. 2002-334092
Patent Document 3: Japanese Unexamined Patent Publication No. 2013-511210
Patent Document 4: Japanese Unexamined Patent Publication No. 2008-058953
Patent Document 5: Japanese Unexamined Patent Publication No. 2009-268036

### Non-Patent Document

Non-Patent Document 1: “Machine learning starting from scratch” (overview of machine learning), retrieved on Sep. 10, 2019, website: https://qiita.com/taki_tflare/items/42a4 0119d3d8e622edd2
Non-Patent Document 2: “Image Recognition by Deep Learning”, Journal of the Robotics Society of Japan [Vol. 35 No. 3 pp. 180-185, 2017] April 2017
Non-Patent Document 3: Amazon “Amazon Rekognition”, retrieved on Sep. 10, 2019, website: https://aws.amazon.com/jp/rekognition/
Non-Patent Document 4: Evixar “Automatic Content Recognition (ACR), Sound Sensing”, retrieved on Sep. 10, 2019, website: https://www.evixar.com/evixaracr
Non-Patent Document 5: Visual Processing Japan “Digital Asset Management”, retrieved on Sep. 10, 2019, website: http://www.cierto-ccc.com/cierto/function html#dam

Live commerce and drama commerce described above for the first background art are examples of e-commerce combined with video content, and the content is produced and distributed mainly for the purpose of selling products (goods and services). Therefore, the audience target is focused on those interested in purchasing the products. On the other hand, video content (films, dramas, cartoons, music videos, etc.) is originally produced and distributed with its storyline, entertainment value, and artistic value. As a result, the audience target can be general viewers of every generation depending on the theme of the video content. In addition, since various resources mentioned above are invested in the production of the video content, if, for example, the research and transaction of the resources can be easily carried out by viewing the video content, those in the industry involved in advertising, marketing, and video content production can also be targeted as viewers. However, the prior art documents cited in the first and second background art sections do not disclose any specific methods or technologies related to such resource research and transactions.

Meanwhile, the e-commerce model called “drama commerce” described in the first background art section relates to an approach that combines so-called product placement (a marketing technique where references to specific companies, products or brands are incorporated into a prop used by actors or background in a film or TV drama) with an e-commerce site. For example, there is a model in which while a scene from a drama is being presented, a product is introduced for sale as “this is the one the actor is wearing in this scene” in the style of home shopping shows or a model that leads the viewer to purchase a product from a link associated with a scene from a drama. In these models, there is a problem in how to deal with mobility in which viewers are intuitively interested in things (goods, services, people, spaces, props, equipment, technology, etc.) from various scenes in a drama. However, the prior art documents cited in the first, second, third, and fourth background art sections do not disclose specific techniques to solve the problem such as, for example, the design of a user interface using a technology related to image recognition AI, audio (acoustic) watermarking, DAM, or the like.

### BRIEF DESCRIPTION OF THE DRAWINGS

FIG. 1 is a schematic diagram relating to a first embodiment;

FIG. 2 is a flowchart illustrating a scene management data generation process;

FIG. 3 is a flowchart illustrating an object detection model creation process;

FIG. 4 is a flowchart illustrating an EC-integrated metamedia distribution process;

FIG. 5 is a schematic diagram relating to the EC-integrated metamedia distribution process;

FIG. 6 is a flowchart illustrating an EC processing process related to products;

FIG. 7 is a flowchart illustrating an audio (acoustic) watermark control process;

FIG. 8 illustrates an example of the format of an edit information sharing file;

FIG. 9 illustrates an example of codes for a machine learning model related to image recognition;

FIG. 10 illustrates an example of codes for a machine learning model related to object detection; and

FIG. 11 illustrates an example of the structure of a main database.

### DETAILED DESCRIPTION

[Method for Creating EC-Integrated Metamedia]

In general, according to one embodiment, a method for creating EC-integrated metamedia comprises the steps of: [a] registering information on a product in a product data management database configured to manage product data; [b] creating an EC product table to manage information related to EC processing of the product; [c] creating an edit information sharing file to share information on editing the video content; [d] creating a scene management file to manage scene information based on information related to scenes in the edit information sharing file and adding thereto a product ID of the product data management database; [e] registering scene data of the scene management file in a scene data management database configured to manage scene data; [f] registering video data of the video content for the public in a video data management database configured to manage video data; and [g] generating trained data for object detection based on scenes in the video data for the public, the scene data in the scene data management database, and the product data in the product data management database.

[System for Distributing EC-Integrated Metamedia]

According to another embodiment, a distribution system is configured to distribute EC-integrated metamedia with a built-in user interface (UI) function for e-commerce that allows viewers of video content (users) to trade a resource for producing the video content as a product. The distribution system comprises a processor configured to: display the video content on a client device of a user (viewer); detect a selection operation by the user to select a scene in the video content on the client device; acquire scene related data, such as identification information for the scene and scene image data at the time of the selection operation, from the client device; detect an object in the scene image data; retrieve product information based on the identification information; check whether the detected object is included in the product information; generate UI-processed scene image data with a link element in a range in which the object is displayed in the scene image data; detect a call operation by the user to call the UI-processed scene image data on the client device; detect a selection operation by the user to select the link element in the UI-processed scene image data, which has been sent to the client device and displayed thereon in response to the call operation, on the client device and acquire the selected link element from the client device; retrieve product information corresponding to the link element and send the product information to the client device; detect a selection operation by the user to select an EC process type for a product in the product information displayed on the client device and acquire the selected EC process type from the client device; and call an EC process for the product based on the EC process type.

[First Method for Distributing EC-Integrated Metamedia]

According to still another embodiment, a distribution method is provided for distributing EC-integrated metamedia with a built-in UI function for e-commerce that allows viewers of video content (users) to trade a resource for producing the video content as a product. A first distribution method comprises the steps of: [a] displaying the video content on a client device of a user; [b] detecting a selection operation by the user to select a scene in the video content on the client device; [c] acquiring identification information for the scene and scene image data at the time of the selection operation from the client device; [d] detecting an object in the scene image data; [e] retrieving product information based on the identification information; [f] checking whether the detected object is included in the product information; [g] generating UI-processed scene image data with a link element in a range in which the object is displayed in the scene image data; [h] detecting a call operation by the user to call the UI-processed scene image data on the client device; [i] detecting a selection operation by the user to select the link element in the UI-processed scene image data, which has been sent to the client device and displayed thereon in response to the call operation, on the client device and acquiring the selected link element from the client device; [j] retrieving product information corresponding to the link element and sending the product information to the client device; [k] detecting a selection operation by the user to select an EC process type for a product in the product information displayed on the client device and acquiring the selected EC process type from the client device; and [1] calling an EC process for the product based on the EC process type.

[Second Method for Distributing EC-Integrated Metamedia]

According to still another embodiment, a second distribution method comprises the steps of: [a] embedding an audio watermark (audio-encoded identification information) in each scene of the video content; [b] broadcasting the video content on a general-purpose viewing device: [c] detecting a selection operation by the user to select a scene in the video content on the client device; [d] acquiring identification information for the scene at the time of the selection operation from the client device; [e] retrieving product information based on the identification information; [f] sending the product information to the client device; [g] displaying the product information on the client device; [h] receiving an EC process performed by the user for a product in the product information displayed on the client device; [i] referring to an EC process type of the product information in response to the EC process; and [j] calling an EC process configuration corresponding to the EC process type.

In one aspect of the embodiments, in addition to products (goods and services) related to video content, resources related to the production of the video content, such as funds, people (including corporations), spaces, props, equipment, and technology involved in the production of the video content, can also be sold or offered for sale directly through e-commerce. This not only facilitates the procurement of resources related to the production of video content but also makes it possible to distribute the profits from e-commerce that is combined with the video content to the suppliers. Thereby, especially in drama production, a scheme that has been dominated by the authority, such as sponsors and broadcasters, can be freed up, allowing production supervisors (e.g., producers, directors, etc.) to better reflect their own vision in their work.

[Outline]

The present disclosure relates generally to a technology for integrating e-commerce with video content such as films, dramas, cartoons (anime), and music videos. An object of an embodiment herein is to provide a method of controlling a system for a new concept e-commerce model that allows viewers of video content to purchase not only products (goods and services) related to the video content, but also various resources (people, spaces, props, equipment, technology, etc.) involved in the production of the video content directly from a screen (site) on which they are viewing the video content.

In order to achieve the above object, an embodiment discloses a configuration to automatically generate a user interface for integrating e-commerce with video content using a technology related to image recognition AI, audio (acoustic) watermarking, DAM, or the like.

Specifically, if the above-mentioned technologies described in the first, second, and fourth background art sections are combined, DAM technology can be used to aggregate information on various resources related to drama production and add metadata thereto, which facilitates access to necessary information. In addition, an e-commerce site can be automatically built with a user interface that is most suitable for the sales targets by converting the data format, changing the data size, or the like. Thus, it becomes possible to provide an e-commerce site integrated with video content, where, for example, when a user (general viewer or consumer) saves a scene of the video content (e.g., a drama) in which something (e.g., a person such as an actor and model, a space such as a popular spot and restaurant used for location shooting, a prop such as a costume and accessory, etc.) they are intuitively interested in has appeared and calls it up later using the user interface, resources (including the object of interest) that are present in the scene are identified through image recognition AI and framed so that the user can select the object to obtain information on the object or purchase the object.

If the above combination is further combined with the technology described in the third background art section, audio (acoustic) watermarking technology can be used to embed an identifier (ID) for identifying each scene in the sound of the drama in the form of inaudible sound at the post-production stage of the drama production process. This enables such a configuration that, for example, when a user is intuitively interested in something while watching the drama on a television in a shopping mall and points their smartphone at the television, a specific application installed on the smartphone obtains the ID from the audio (acoustic) watermark embedded in the sound of the drama via the microphone and sends it to the center server, which calls up an e-commerce site that displays a scene corresponding to the ID (the scene the smartphone was pointed at, i.e., the scene where the object of interest appeared), allowing the user to select the object from resources in the scene identified and framed through image recognition AI to obtain information on the object or purchase the object.

According to an embodiment, resources related to the production of video content (e.g., film, drama, cartoon, music video, etc.), such as funds, people (including corporations), spaces, props, equipment, and technology involved in the production of the video content, can also be sold or offered directly through e-commerce. This facilitates the procurement of resources related to the production of video content.

According to an embodiment, it is possible to distribute the profits from e-commerce that is combined with video content (e.g., film, drama, cartoon, music video, etc.) to the suppliers. Thereby, especially in drama production, a scheme which has been dominated by the authority, such as sponsors and broadcasters, can be freed up, allowing production supervisors (e.g., producers, directors, etc.) to better reflect their own vision in their works.

According to an embodiment, it is possible to provide an e-commerce site integrated with video content (e.g., film, drama, cartoon, music video, etc.), where a viewer (consumer) of, for example, a drama can use a user interface to save a scene of the drama in which something they are intuitively interested in has appeared and call it up later so that they can select the object of interest from the image of the scene to obtain information on the object or purchase the object.

The first embodiment is characterized by the distribution of metamedia integrated with an e-commerce function that allows users to easily and directly purchase things (products) from a scene of video content while viewing the video content with a specialized viewing system. The second embodiment is directed to an e-commerce function that enables easy and direct purchase of products sold or offered in video content from the scenes without the need for a specialized viewing system.

### First Embodiment

The first embodiment will be described in detail below.

The first embodiment comprises “scene management data generation process”, “object detection model creation process”, “EC-integrated metamedia distribution process”, and “EC processing process related to products”.

The scene management data generation process is the process of identifying all resources that can be sold or offered as products, and generating and recording information about each product and an EC process type for each product (the configuration of the EC process is determined according to the transaction type of the product, such as purchase and contract) to commercialize various resources (people, spaces, props, equipment, technology, etc.) involved in the production of video content such as films, dramas, cartoons, and music videos so that viewers can easily purchase them through electronic commerce (e-commerce or EC).

When the decision is made to produce such video content as mentioned above, resources to be invested in the video content are carefully planned. In addition, how to procure the resources is also planned based on clear information. Accordingly, the EC process procedure is determined based on information about the procurement way.

Specifically, the scene management data generation process includes: (1) a first step for creating an EC product table that contains information about products, i.e., resources that can be sold or offered (detailed information on each product and information about an EC process type for each product, composed of digital data such as images, sounds, letters, and symbols) and associating the table with a product management database, (2) a second step for shooting (recording) a video, (3) a third step for creating an XML file from the shot (recorded) video (recording the scene ID) using video editing software (example), (4) a fourth step for creating a scene management file from the XML file using a format conversion program (in-house developed), (5) a fifth step for adding a node related to basic information (example) to the scene management file, (6) a sixth step for registering dynamic information (example) and a product ID (adding a node) for each scene of the edited video using an information/product registration program (in-house developed), (7) a seventh step for assigning a scene ID to each scene data (basic information, dynamic information, product ID, etc.) from the scene management file after registration using a scene data generation program (in-house developed) and storing the scene data in a scene data management database to make a database of the scene data, and (8) an eighth step for assigning a video ID to the final version of the edited video using a video data storage program and storing it in a video management database to make a database of video data available to the public.

Note that the scene management data generation process need not always include the second step (2) of shooting (recording) a video when, for example, video data of video content recorded by a third party (video content creator) is available.

The object detection model creation process is the process of enhancing the ability of image recognition AI to instantly determine whether things (goods, services, people, spaces, props, equipment, technology, etc.), in which viewers are intuitively interested in various scenes of video content such as films, dramas, cartoons, and music videos, each fall into the category of products for e-commerce.

Specifically, the object detection model creation process includes: (1) a first step for creating learning data from each scene of the edited video, scene data, and product data using a learning model creation program, (2) a second step for determining the detection accuracy of a learning model while improving the learning model by machine learning with the created learning data, and (3) a third step for outputting the learning model (containing a product ID) when its detection accuracy has reached a certain level and saving it in a dedicated save file.

The EC-integrated metamedia distribution process is the process of distributing metamedia that integrates video content, such as a film, drama, cartoon, and music video, with an e-commerce function that enables the commercialization of various resources (people, spaces, props, equipment, technology, etc.) involved in the production of the video content.

Specifically, the EC-integrated metamedia distribution process includes: (1) a first step in which when a user accesses the system of the center with a PC or smartphone (e.g., by clicking/touching on a link related to “EC-integrated metamedia distribution service” displayed on a portal site in a web browser), the center system redirects the user to “EC-integrated metamedia distribution site”, (2) a second step in which when the user selects a video (video content such as a film, drama, cartoon, music video, etc.) of their choice from those displayed on the EC-integrated metamedia distribution site, a specialized or original video player is downloaded to their PC or smartphone, (3) a third step in which when the user clicks/touches the play button on the original video player, the selected video is played (viewed), (4) a fourth step in which when the user selects a scene during video playback (e.g., by clicking/touching the screen), the center system acquires scene identification information (video ID, time code, etc.) and image data of the scene at that time, (5) a fifth step for retrieving scene data (scene ID, basic information, dynamic information, product ID list, etc.) from the scene data management database based on the scene identification information, (6) a sixth step for searching a product data management database based on the product ID list of the acquired scene data and verifying the product ID (checking whether a product is in stock, etc.), (7) a seventh step for detecting a product ID list contained in the scene image by the object detection process (estimation by the learning model) based on the scene image data, (8) a eighth step for collating the verified product ID list from the sixth step with the product ID list from the seventh step and performing UI processing (creating rectangular frames, linking, etc.) on product images with matching product IDs, and (9) a ninth step in which when the user clicks/touches on a rectangular area, a corresponding product is extracted and displayed.

The user can be provided with the original video player by running a dedicated web application on a web browser or by installing a dedicated application on their smartphone and running it.

The EC processing process related to products is the process in which viewers of the EC-integrated metamedia purchase products contained in each scene through the e-commerce function, and the proceeds of sales from such purchases are distributed not only to product suppliers but also to the producer of the video content.

Specifically, the EC processing process related to products includes: (1) a first step in which the user determines the type of EC process (purchase, contract, bid, etc.) for the product displayed by the ninth step of the EC-integrated metamedia distribution process (by menu selection, etc.), (2) a second step in which product information is displayed, and the user decides to purchase the product, (3) a third step in which the user enters order information, and the payment is processed, (4) a fourth step in which order receipt information is sent to the center system, (5) a fifth step in which the center sends order information (shipping address, shipping conditions, payment conditions, and payment information) to the product supplier, (6) a sixth step in which the product is delivered to the user from the product supplier based on the order information, and (7) a seventh step in which the product price is paid to the product supplier, the dividend is paid to the producer, and the commission is paid to the center.

A server specific program and client (PC, smartphone, etc.) specific application for implementing each step of the processes described above can be developed with JAVA, C, C++, JavaScript, Python, or the like. For example, general-purpose software such as Blackmagic Design's DaVinci Resolve (AFF, XML) and Sony Vegas Pro (AAF) can be used for video editing, and Evixar's SDK, which is mentioned in Non-Patent Document 4, can be used for audio (acoustic) watermark control.

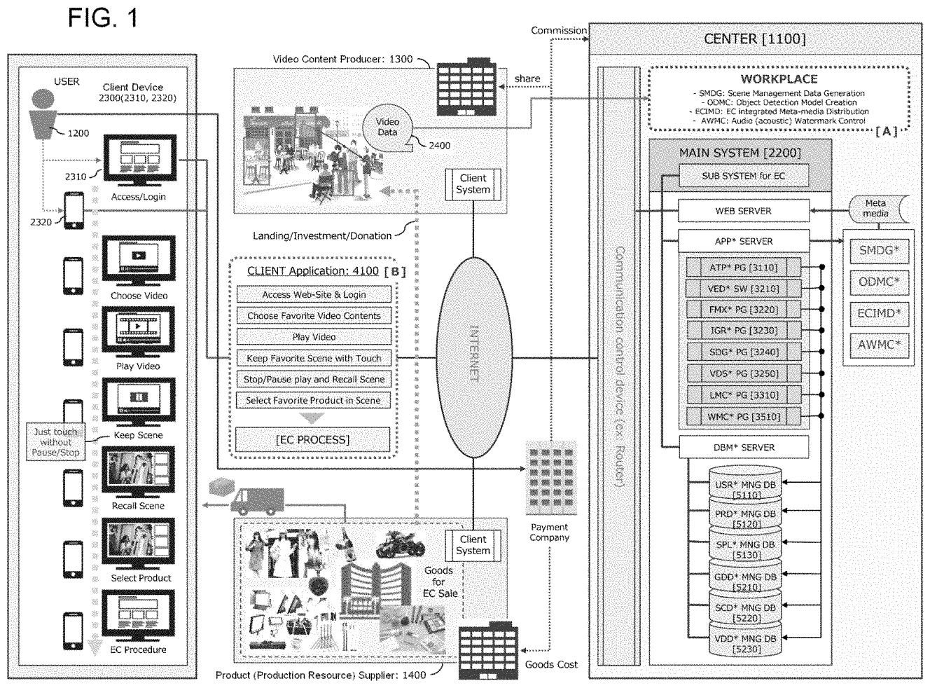

FIG. 1 is a schematic diagram illustrating a method for creating EC-integrated metamedia and a distribution system according to an embodiment.

In FIG. 1, abbreviations marked with an asterisk (*) stand for as follows:

[Main System]
APP*=APPLICATION
DBM*=DB MANAGEMENT

[App*Server]
ATP*=Authentication Process
VED*=Video Edit
FMX*=Format Exchange
IGR*=Info & Goods (Product) Register
SDG*=Scene Data Generator
VDS*=Video Data Storage
LMC*=Learning Model Creator
VDP*=Video Player
WMC*=Watermark Control
[DBM*SERVER]

USR*=User
PRD*=Producer
SPL*=Supplier
GDD*=Goods (Product) Data
SCD*=Scene Data
VDD*=Video Data

In the following, the main processes according to an embodiment, indicated by [A] in FIG. 1, will be described with reference to FIG. 1 and detailed drawings for the processes.

[Scene Management Data Generation Process]

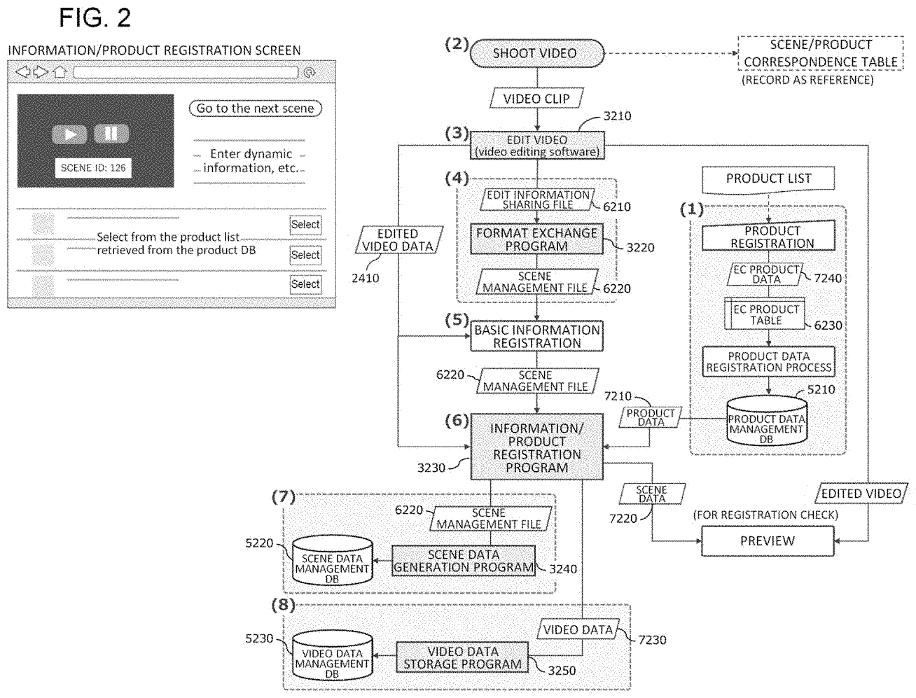

FIG. 2 is a flowchart of the scene management data generation (SMDG) process indicated by [A] in FIG. 1.

The scene management data generation process is the process of identifying all resources that can be sold or offered as products, and generating and recording information about each product and an EC process type for each product (information to invoke a configuration to implement an EC process appropriate for the transaction type of the product such as, for example, the purchase of the product, a contract when a human resource, equipment, or technology is offered as the product, or bidding when the product is listed in an auction) to commercialize various resources (human resources such as individual or corporation investors, directors, original authors, screenwriters, casting directors, actors, voice actors, music producers, performers, interpreters, translators, film crew, editorial staff, lighting crew, set designers, costume designers, stylists, hair designers, makeup artists, action choreographers, stunt doubles, and extras; spaces such as a filming location or studio where scenes are filmed; props such as animals, vehicles, costumes, ornaments, and interior goods; equipment such as cameras and lights; technology resources and tools used for computer graphics, recording, and editing, etc.) involved in the production of video content such as films, dramas, cartoons, and music videos so that viewers can easily purchase them through the e-commerce function. The scene management data generation process is composed of eight main steps.

In the first step (1) in FIG. 2, an EC product table 6230 is created based on EC product data 7240 that includes information on products (things described above as resources that can be offered for sale) that can be sold or offered by the EC-integrated metamedia of the embodiment (detailed information on each product and information about an EC process type for each product, composed of digital data such as images, sounds, letters, and symbols), and the EC product ID of the EC product table 6230 is stored in a product data management database 5210 by the product data registration process.

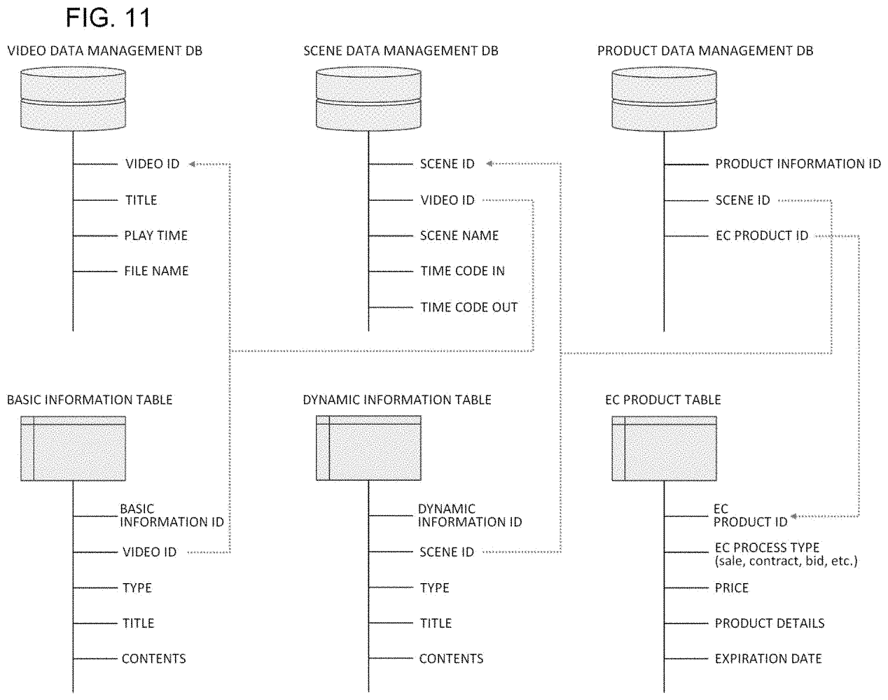

FIG. 11 illustrates an example of the structure of the product data management database 5210 and the EC product table 6230.

In the second step (2) in FIG. 2, a video content producer 1300 shoots video content such as a film, drama, cartoon, or music video using resources provided by a product (production resource) supplier 1400 illustrated in FIG. 1 through lending, investment, donation or the like, and recorded video data 2400 is sent (or mailed) to a center 1100.

The video data 2400 is incorporated into the EC-integrated metamedia distribution at the center 1100.

In the third step (3) in FIG. 2, the video data 2400 sent to the center 1100 in the second step is edited by video editing software 3210 (VED*SW in FIG. 1), and an edit information sharing file 6210 (e.g., in XML format) is output.

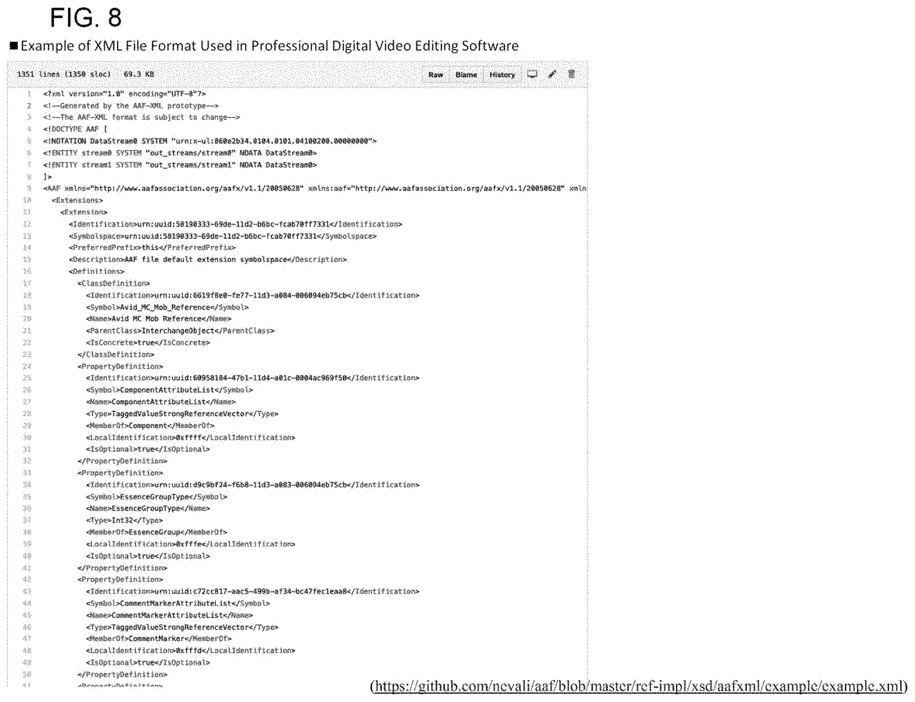

The edit information sharing file 6210 contains basic information necessary to create EC-integrated metamedia (information about the video, scenes, etc.). FIG. 8 illustrates an example of the format of the file.

In the fourth step (4) in FIG. 2, a scene management file 6220 is generated by a format exchange program 3220 (FMX*PG in FIG. 1) based on the edit information sharing file 6210 output in the third step.

The scene management file 6220 records all information about scenes required for EC-integrated metamedia distribution.

In the fifth step (5) in FIG. 2, nodes (tags in a document that represent data in a hierarchical manner) related to basic information (e.g., uniform information throughout the video such as video description, information on a drama or a match, event name and the date and time, etc.) are added to the scene management file 6220 generated in the fourth step.

In the sixth step (6) in FIG. 2, dynamic information (e.g., information that changes from scene to scene, such as filming location, music, scene description, etc.; FIG. 11 illustrates an example of the structure) and the product ID of product data 7210 of the product data management database 5210 are registered (nodes are added) in the scene management file 6220, to which the basic information has been added in the fifth step, by an information/product registration program 3230 (IGR*PG in FIG. 1) for each scene in the edited video.

In the seventh step (7) in FIG. 2, data of each scene (basic information, dynamic information, product ID, etc.) is extracted from the scene management file 6220, to which the dynamic information has been added in the sixth step, and is assigned a scene ID by a scene data generation program 3240. The data is registered in a scene data management database 5220 as scene data 7220.

In the eighth step (8) in FIG. 2, the final version of edited video data 2410 obtained in the third step is assigned a video ID by a video data storage program 3250 and is stored in a video data management database 5230 as video data 7230 (video data available to the public).

[Object Detection Model Creation Process]

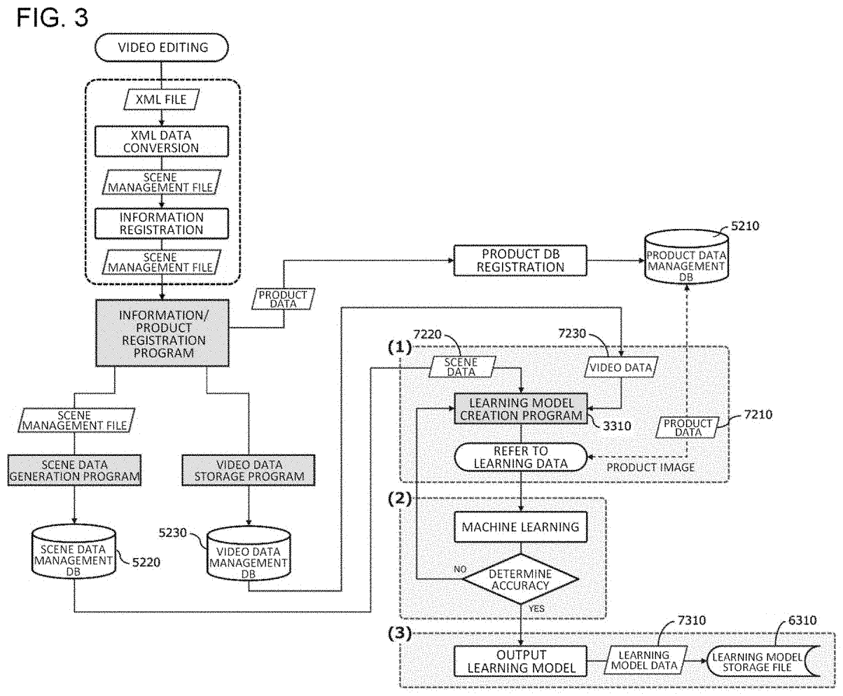

FIG. 3 is a flowchart of the object detection model creation (ODMC) process indicated by [A] in FIG. 1.

The object detection model creation process or the second step thereof is performed to add and enhance the AI function related to object detection necessary to build a system for providing viewers of video content, such as films, dramas, cartoons, and music videos, with a user interface (UI) that enables them to easily determine whether things (goods, services, people, spaces, props, equipment, technology, etc.), in which they are intuitively interested in various scenes of the video content, are each available as a product for e-commerce or whether information for purchase can be viewed. The object detection model creation process is composed of three main steps.

In the first step (1) in FIG. 3, learning data for machine learning is created by a learning model creation program 3310 (LMC*PG in FIG. 1) based on each scene of the video data 7230 stored in the video data management database 5230 so as to be available to the public in the eighth step of the scene management data generation process, the scene data 7220 stored in the scene data management database 5220, and the product data 7210 stored in the product data management database 5210.

In the second step (2) in FIG. 3, the detection accuracy of a learning model is determined while being improved by machine learning using the learning data created in the first step.

In the third step (3) in FIG. 3, when the accuracy of the learning model has reached a certain level through the machine learning in the second step, the learning model with an accuracy at or above the certain level is stored in a learning model storage file 6310 as trained learning model data 7310.

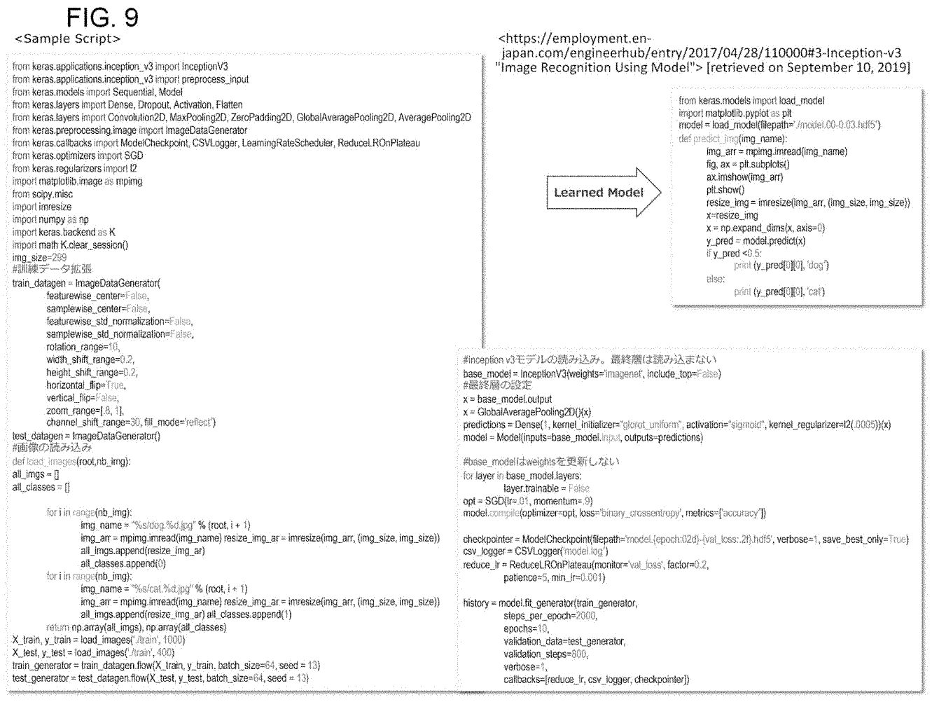

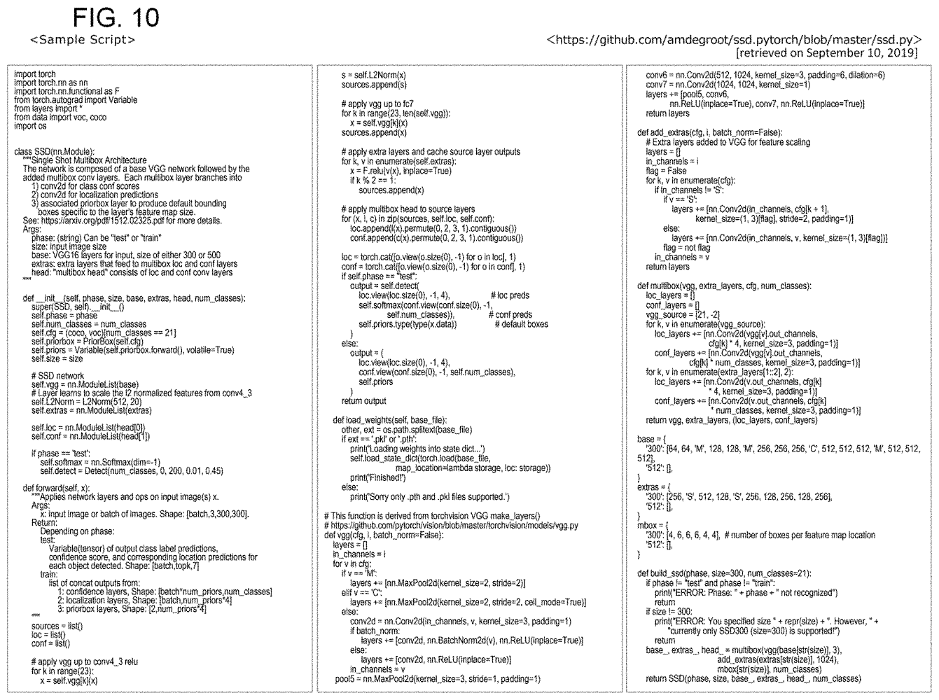

A lot of information on libraries used for such a learning model creation program as above can be found on the Internet as well as in books. For example, Keras, written in Python, has been developed with an emphasis on enabling a quick experiment as a high-level neural network library that can be run on TensorFlow, CNTK, and Theano, and is widely available to the public. There is an online article about a script using Keras for image recognition of animals (dogs and cats) and a learning model obtained as a result of executing it on the following website: https://employment.en-japan.com/engineerhub/entry/2017/04/28/110000#3-Inception-v3 (retrieved on Sep. 10, 2019). For another example, PyTorch is a Python library for deep learning, and the code for deep object detection is described on the following website: https://github.com/amdegroot/ssd.pytorch/blob/master/ssd.py (retrieved on Sep. 10, 2019). FIG. 9 illustrates an example of the machine learning code for image recognition mentioned above. FIG. 10 illustrates an example of the machine learning code for object detection mentioned above.

[EC-Integrated Metamedia Distribution Process]

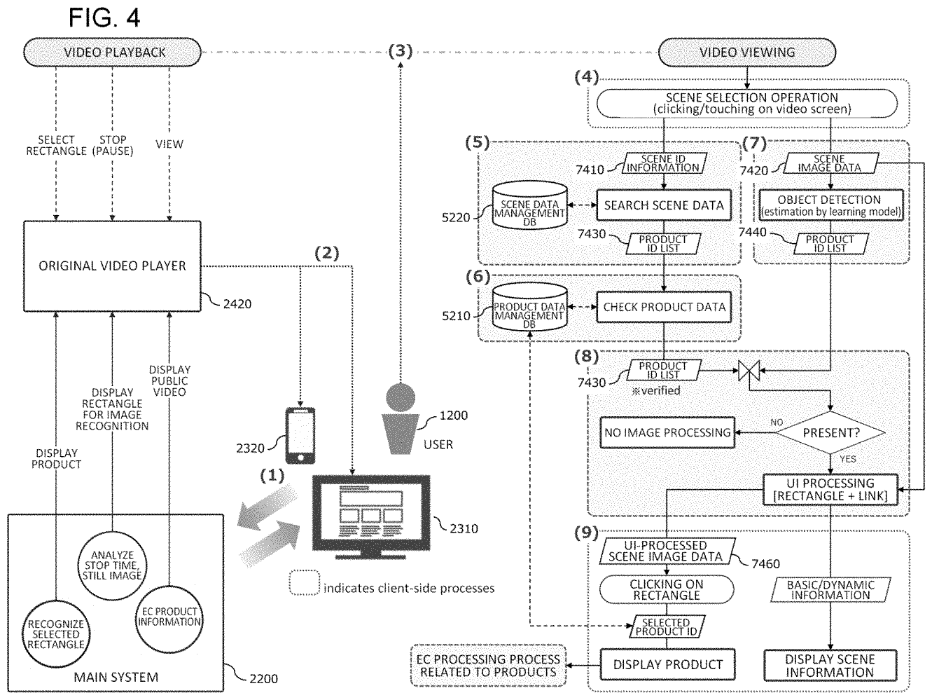

FIG. 4 is a flowchart of the EC-integrated metamedia distribution (ECIMD) process indicated by [A] in FIG. 1.

In the aforementioned live commerce and drama commerce, video content is distributed to promote products that are already out on the market or new products that are going to be released. The distribution system for video content and the sales system for existing or new products are separated and just simply linked together. Regarding the products offered, it is not that they are only available there.

The EC-integrated metamedia distribution process of this embodiment is the process of distributing metamedia that integrates video content with an e-commerce function that allows viewers of the video content such as films, dramas, cartoons, and music videos to purchase products easily and directly from a system for viewing it. In other words, the EC-integrated metamedia distribution process is the process of distributing metamedia where various resources (people, spaces, props, equipment, technology, etc.) involved in the production of the video content are also available as products for e-commerce. The EC-integrated metamedia distribution process is composed of nine main steps.

In the first step (1) in FIG. 4, when a user 1200 accesses a main system 2200 of the center with a client device such as a PC 2310 or a smartphone 2320 by, for example, clicking (touching) on a link related to “EC-integrated metamedia distribution service” displayed on a portal site in a web browser, the main system 2200 redirects the user to “EC-integrated metamedia distribution site”.

In the second step (2) in FIG. 4, for example, when the user 1200 selects a video (video content such as a film, drama, cartoon, music video, etc.) of their choice from those displayed on the EC-integrated metamedia distribution site where they are redirected in the first step, an original video player 2420 is downloaded from the main system 2200 to the client device such as the PC 2310 or the smartphone 2320 of the user 1200.

The user can be provided with the original video player 2420 by running a web application on a web browser or by installing a dedicated application on their smartphone and running it.

In the third step (3) in FIG. 4, when, for example, the user 1200 clicks (touches) the play button on the original video player 2420, the selected video is played (viewed by the user)

In the fourth step (4) in FIG. 4, when the user selects a scene during the playback of the video, which has started playing on the original video player 2420 in response to the user operation in the third step, by, for example, clicking (touching) the screen, the main system 2200 acquires scene identification information 7410 (including a video ID, scene ID, time code, etc.) and image data 7420 of the scene at the time of clicking (touching).

The main system 2200 may acquire the scene identification information 7410 and the scene image data 7420, for example, in the following manner: the original video player 2420 acquires the scene identification information 7410 and the scene image data 7420 in response to a scene selection operation and sends them to the main system 2200; the main system 2200 monitors information related to video playback on the original video player 2420 and directly acquires the scene identification information 7410 and the scene image data 7420 when a scene is selected; or the main system 2200 acquires only the scene identification information 7410, extracts video data corresponding to the video ID of the scene identification information 7410 stored in the video data management database 5230 in the scene management data generation process described above (step (8) in FIG. 2), and uses scene data that can be extracted from the video data based on the scene ID of the scene identification information 7410 as substitute data for the scene image data 7420.

In the fifth step (5) in FIG. 4, scene data is searched based on the scene identification information 7410 (including a video ID, scene ID, time code, etc.) acquired by the main system 2200 in the fourth step, and corresponding scene data (including a video ID, scene ID, basic information, dynamic information, product ID list, etc.) is retrieved from the scene data management database 5220.

In the sixth step (6) in FIG. 4, product data is checked against a product ID list 7430 contained in the scene data retrieved in the fourth step, i.e., the product data management database 5210 is searched for product data based on the product ID list 7430, and the product ID list is verified (whether a corresponding product is in stock or out of stock is checked) by checking whether there is product data corresponding to the product ID list 7430.

In the seventh step (7) in FIG. 4, a product ID list 7440 contained in the scene image data 7420 acquired in the fourth step is detected by the object detection process (estimation by the learning model) based on the scene image data 7420 (concurrently with the fifth step).

In the eighth step (8) in FIG. 4, the product ID list 7430 verified by the product data check in the sixth step is collated with the product ID list 7440 detected by the object detection in the seventh step. Then, UI processing (creating a rectangular frame, providing a link for obtaining product data through a product ID, etc.) is performed on a product image (a product image contained in the scene image data 7420) with a product ID that has been confirmed to be present by checking the presence of the product ID (e.g., checking whether a product ID listed in the product ID list 7440 is present in the product ID list 7430) to create UI-processed scene image data 7460.

In the ninth step (9) in FIG. 4, the UI-processed scene image data 7460 (there may be more than one) obtained by the UI processing in the eighth step is sent to the client device such as the PC 2310 or the smartphone 2320 and displayed thereon. In response to the display of the UI-processed scene image data 7460, when, for example, the user 1200 clicks (touches) on a rectangular area for a product image in the UI-processed scene image data 7460, product data corresponding to the product image is extracted from the product data management database 5210 to be displayed.

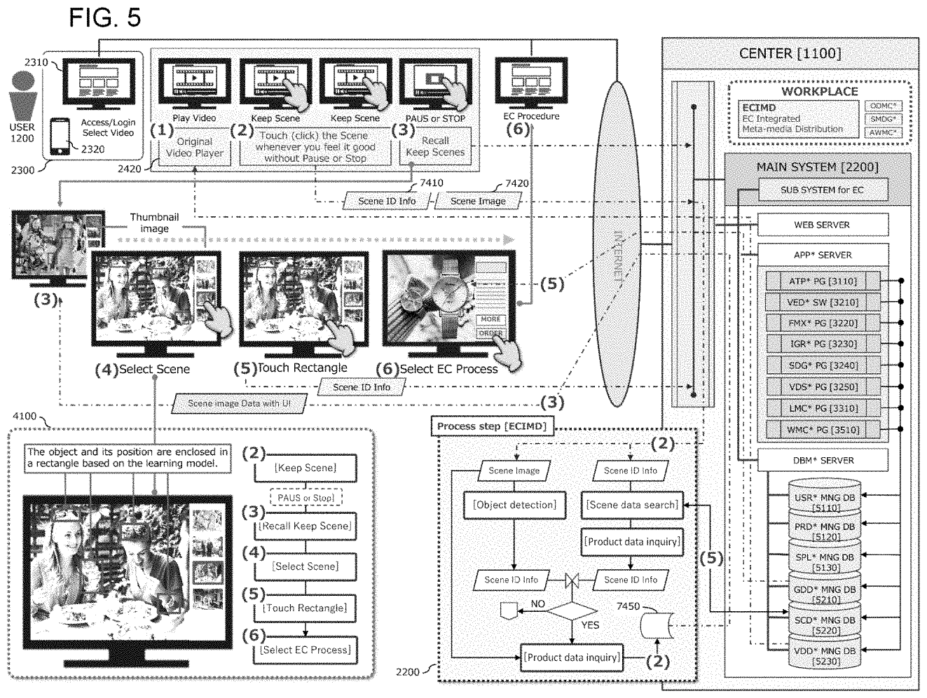

The EC-integrated metamedia distribution process is a characteristic feature of this embodiment. Therefore, further to the above description given in connection with the flowchart of FIG. 4, a specific example of how it is implemented on the client side, indicated by [B] in FIG. 1 (except for [EC PROCESS]), will be described referring to the schematic diagram of FIG. 5 along with processes (1) to (6) (linked processes are designated by the same number) illustrated therein.

[EC-Integrated Metamedia Distribution Process (Second Explanation)]

In the process (1) in FIG. 5, the user 1200 accesses the EC-integrated metamedia distribution site from a client device 2300 such as the PC 2310 or the smartphone 2320. Then, when the user 1200 selects a video (video content such as a film, drama, cartoon, or music video), (1) the video is played on the original video player 2420.

In the process (2) in FIG. 5, when intuitively interested in a scene of the video during the playback, for example, the user 1200 touches (clicks) on the scene image of the video. As a result, the main system 2200 receives (acquires) the scene identification information 7410 and the scene image data 7420 related to the scene image at the time of clicking (touching).

Incidentally, the system may be configured so that the user 1200 can perform the operation (scene selection operation) during the video playback as many times as they need without suspending (pausing) or stopping the playback.

After the main system 2200 of the center receives (acquires) the scene identification information 7410, the fifth to eighth steps of the EC-integrated metamedia distribution process are performed in the main system 2200 to create the UI-processed scene image data 7460.

When the scene selection operation has been performed a plurality of times, the UI-processed scene image data 7460 sent by the operation may be stored in a scene identification information save file 7450.

In the process (3) in FIG. 5, for example, when the user 1200 suspends (pauses) or stops the video playback and performs a scene call operation, the UI-processed scene image data 7460 stored as described above is sent from the scene identification information save file 7450 to the client device 2300. When there is a plurality of sets of the UI-processed scene image data 7460, for example, the first UI-processed scene image data is displayed in the main area of the display screen of the client device, and the rest is displayed in thumbnail format in the side area.

In the process (4) in FIG. 5, when the user 1200 selects (touches or clicks) any one of the thumbnails of the sets of the UI-processed scene image data 7460 displayed on the client device 2300, the selected UI-processed scene image data 7460 is displayed in the main area.

In the process (5) in FIG. 5, when the user 1200 selects any one of object images each surrounded by a rectangular frame (touches or clicks on a rectangular area) in the selected UI-processed scene image data 7460, link data (including a product ID) corresponding to the selected object image is sent to the main system 2200 of the center. Then, corresponding product data is extracted from the product data management database based on the product ID of the link data, and the extracted product data is sent to the client device 2300.

In the process (6) in FIG. 5, the product information of the product data sent to the client device 2300 is displayed on the client device 2300. When the user 1200 selects the type of EC process for the product (e.g., checking detailed information on the product, making an inquiry about the product, purchasing the product, etc.), the selected EC process is to be performed.

The processes according to an embodiment, indicated by [A] in FIG. 1, have been described in detail above.

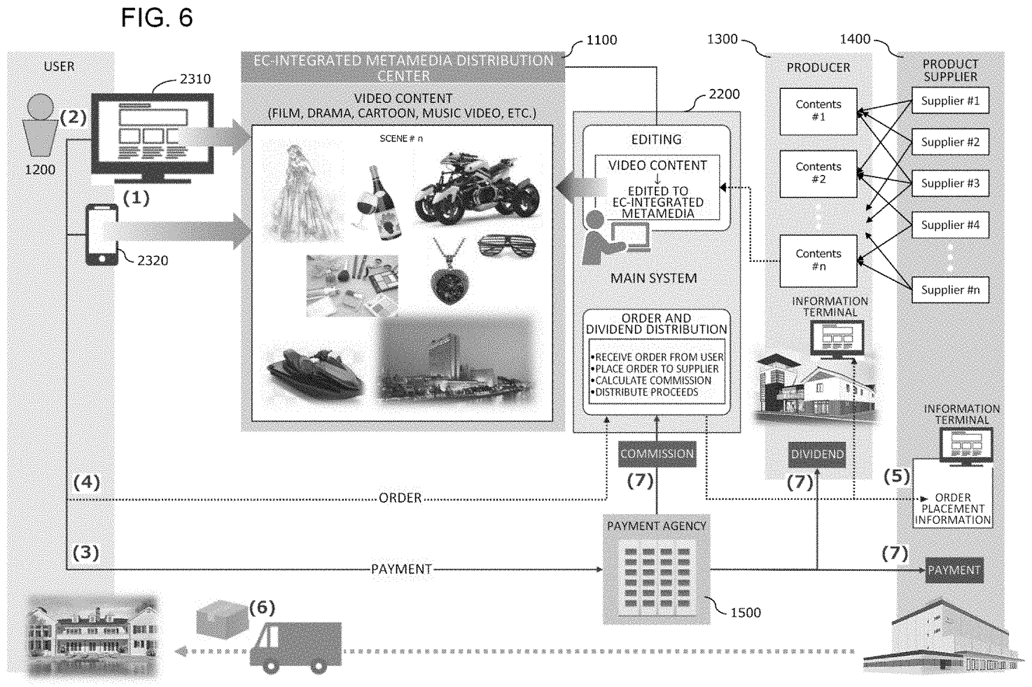

Next, the EC processing process related to products according to an embodiment, indicated by [B] ([EC PROCESS]) in FIG. 1, will be described with reference to FIGS. 1 and 6.

[EC Processing Process Related to Products]

FIG. 6 is a schematic diagram illustrating the EC processing process related to products implemented by a client application 4100 indicated by [B] in FIG. 1, i.e., a Web application downloaded to the client device of the user 1200 such as the PC 2310 or the smartphone 2320 illustrated in FIG. 1 or a dedicated application installed on the client device.

The EC processing process related to products according to the embodiment is the process in which viewers of EC-integrated metamedia purchase products contained in each scene of video content, such as a film, drama, cartoon, and music video, distributed by the EC-integrated metamedia, i.e., not only general e-commerce products but also various resources (people, spaces, props, equipment, technology, etc.) involved in the production of the video content, through an e-commerce function integrated with the video content, and the proceeds of sales from such purchases are distributed not only to product suppliers (those who sell the resources or those who provide the resources through lending, investment, donation or the like) but also to the producer of the video content and the center. The EC processing process related to products is composed of seven main steps.

In the first step (1) in FIG. 6, the user 1200 decides the type of EC process for the product (information to invoke a configuration to implement an EC process appropriate for the transaction type of the product such as, for example, the purchase of the product, a contract when a human resource, equipment, or technology is offered as the product, or bidding when the product is listed in an auction), which is selected by touching a rectangular area and displayed on the PC 2310 or the smartphone 2320 in the ninth step of the EC-integrated metamedia distribution process (e.g., by clicking or touching on one of the menu options of the type).

In the second step (2) in FIG. 6, after the type of EC process is selected in the first step, detailed information about the product is displayed, and the user 1200 decides the purchase of the product.

In the third step (3) in FIG. 6, the user 1200 enters, as order information for the product that they have decided to purchase in the second step, for example, information on a person that orders (purchases) the product (in this case, information on the user 1200) and delivery information such as delivery address and contact information to make a payment for the purchase of the product. As a result, for example, a payment agency 1500 debits the purchase price of the product from a bank account of the user 1200.

The main system 2200 of the center may be configured to accept a login request (user authentication process, which is performed by ATP*PG [3110] illustrated in FIG. 1 in this embodiment) from the user 1200 in the first or second step. In this case, the entry of order information can be eliminated in the third step. Such a configuration can be easily achieved with the use of a membership registration system of existing e-commerce sites or the like.

As to the timing at which the purchase price is debited from the bank account of the user 1200 through the above payment process, a cooling-off period may be applied depending on the type of the product purchased by the user 1200.

In the fourth step (4) in FIG. 6, the order information entered by the user 1200 in the third step and order receipt information processed by the payment agency 1500 based on the payment made by the user 1200 are sent to the main system 2200 of the center.

In the fifth step (5) in FIG. 6, the main system 2200 of the center sends order placement information to an information terminal of the product supplier 1400 (e.g., by email) based on the order receipt information received in the fourth step. Additionally, a notification about the order placement information is sent to an information terminal of the producer 1300.

In the sixth step (6) in FIG. 6, the product is delivered from the product supplier 1400 to the user 1200 (if the delivery address indicated by the order information is the address of the user 1200) based on the order placement information sent to the product supplier 1400 in the fifth step.

In the seventh step (7) in FIG. 6, from the purchase price (sales proceeds) collected by the payment agency 1500 in the third step, the product price is paid to the product supplier 1400, a dividend is paid to the producer 1300, and a commission is paid to the center 1100.

In the above example, viewers of the EC-integrated metamedia and users who purchase a product are described as general consumers. However, the viewers include, for example, people in various industries such as entertainment, advertising, and marketing, as well as producers of video content, and also developers of new products and services. The products that those viewers are likely to purchase (trade) may include, for example, the hiring of people such as models and stunt doubles, the use of hotels and restaurants in a filming location, and the application of technologies such as special effects and computer graphics. Therefore, it is necessary to build an e-commerce function that can handle such transactions. In recent years, with the development of Internet technology, deregulation, and blockchain technology, it has become possible to trade products that involve a contract, such as travel, insurance, securities, and education, through innovations such as smart contracts. In addition, e-commerce systems are being developed to support this type of transaction. If such a transaction concept is incorporated into the EC processing process related to products of the embodiment, it is easy to build a function that can invoke a configuration to implement an EC process appropriate for the transaction type of a product such as, for example, a contract when the hiring of people, use of equipment, lending of technology, or the like is offered as the product, and bidding when the product is listed in an auction.

As described above, according to the first embodiment, it is possible to provide a method for creating EC-integrated metamedia, where not only products (goods, items and services) related to video content but also various resources involved in the production of the video content can be sold or offered directly through e-commerce, and a method for controlling a distribution system.

### Second Embodiment

The second embodiment will be described in detail below. The second embodiment further comprises “audio (acoustic) watermark control process” in addition to the scene management data generation process, object detection model creation process, and EC processing process related to products described in the first embodiment.

The scene management data generation process, object detection model creation process, and EC processing process related to products have already been described in detail in the first embodiment, and therefore the same description will not be repeated.

The audio (acoustic) watermark control process includes two processes: “audio encoding process” for embedding an audio (acoustic) watermark in EC-integrated metamedia, and “audio decoding process” for detecting the audio (acoustic) watermark embedded in the EC-integrated metamedia.

The audio encoding process includes three steps: (1) a first step for generating scene identification information from the video ID and scene ID of scene data using scene data stored by a scene data generation program in the scene data management database from the scene management file edited by an information/product registration program, and scene data and edited video stored in the video data management database from the final version of edited video data by a video data storage program in the scene management data generation process described in the first embodiment, (2) a second step for encoding the generated scene identification information into audio (acoustic) watermark data using dedicated audio (acoustic) watermark control software, and (3) a third step for re-editing the video by embedding the audio (acoustic) watermark data in each scene of the edited video using video editing software.

The audio decoding process includes: (1) a first step for picking up the sound of EC-integrated metamedia output from a television when, for example, a user points their smartphone (smartphone's microphone), on which a dedicated application with an audio (acoustic) watermark control function is installed, at video content of the EC-integrated metamedia that is being distributed (broadcasted or reproduced) on the television and acquiring audio (acoustic) watermark data from the sound by the dedicated application, and (2) a second step for decoding the audio (acoustic) watermark data to detect scene identification information (including a video ID and scene ID).

For example, when the detected scene identification information is sent from the user's smartphone to the main system of the center, product list data based on the scene identification information is generated from the product data management database. The product list data is sent from the main system to the user's smartphone and displayed on the smartphone. The user can then proceed to the selection of an EC process to purchase a product of their choice from the product list.

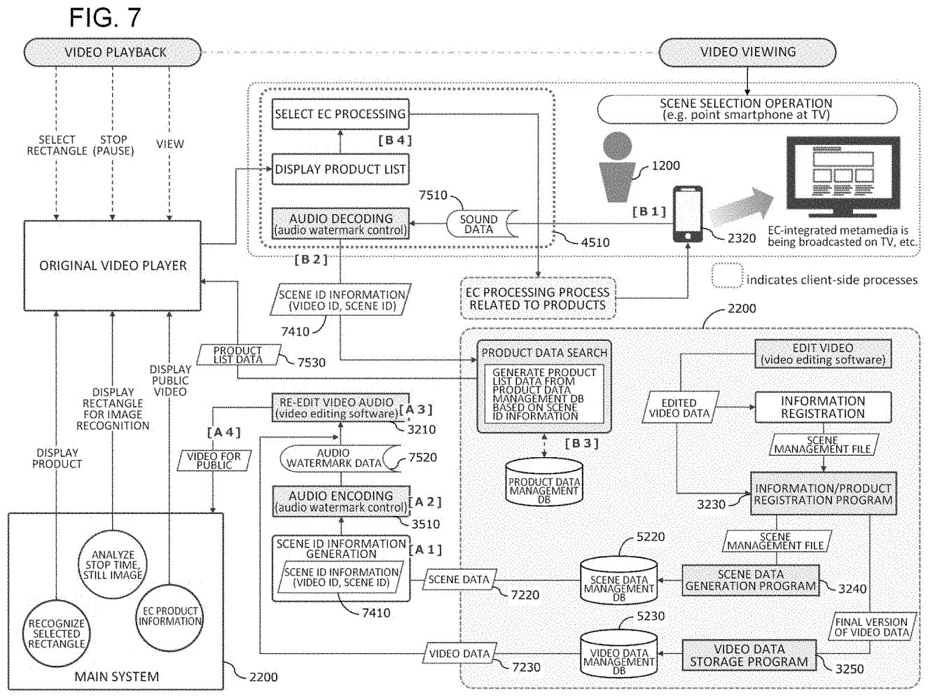

FIG. 7 is a flowchart of the audio (acoustic) watermark control process according to the second embodiment, in which the audio encoding process corresponds to a flow of steps [A1] to [A4], and the audio decoding process corresponds to a flow of steps [B1] to [B4]. [Audio (Acoustic) Watermark Control Process/Audio Encoding Process]

The audio encoding process in the audio (acoustic) watermark control process of this embodiment is the process of synthesizing text data of scene identification information into inaudible sound and embedding it in each scene of a video for the public (by editing the video audio). The audio encoding process is composed of three main steps.

In the first step [A1] in FIG. 7, the scene data 7220 is extracted from the scene data management database 5220 based on the video ID of a video in which an audio (acoustic) watermark is to be embedded through the process of generating scene identification information, and the scene identification information 7410 including the video ID and the scene ID of the scene data 7220 is generated.

In the second step [A2] in FIG. 7, the scene identification information 7410 generated in the first step is encoded into audio (acoustic) watermark data 7520 by the dedicated audio (acoustic) watermark control software 3510.

In the third step [A3] in FIG. 7, the video data 7230 is retrieved from the video data management database 5230 based on the video ID of the video in which an audio (acoustic) watermark is to be embedded. The video data 7230 is re-edited by the video editing software 3210 while the audio watermark data 7520 encoded in the second step is being embedded in each scene of the video data 7230.

[Audio (Acoustic) Watermark Control Process/Audio Decoding Process]

The audio decoding process in the audio (acoustic) watermark control process of this embodiment is the process of extracting the scene identification information from the audio watermark (text data of the scene identification information synthesized into inaudible sound) embedded in each scene of the video for the public. The audio decoding process is composed of four main steps.

In the first step [B1] in FIG. 7, when the user 1200 selects a scene by pointing the smartphone 2320, on which a dedicated application 4510 with an audio (acoustic) watermark control function is installed, at video content (the edited video described above for the audio encoding process) of EC-integrated metamedia that is being distributed (broadcasted or reproduced) on a television, the microphone of the smartphone 2320 picks up the sound (sound waves) of the EC-integrated metamedia. The dedicated application 4510 generates sound data 7510 based on the sound (sound waves) and acquires audio (acoustic) watermark data corresponding to a scene of the video content being displayed at the time of picking up the sound for the sound data.

In the second step [B2] in FIG. 7, the dedicated application 4510 detects the scene identification information 7410 (including a video ID and scene ID) corresponding to the scene at the time of picking up the sound from the acquired audio watermark data by its audio decoding function. The scene identification information 7410 is sent to the main system 2200 of the center.

In the third step [B3] in FIG. 7, product list data 7530 is generated from the product data management database 5210 through the process of searching for product data based on the scene identification information 7410 sent to the main system 2200. The product list data 7530 is sent to the smartphone 2320.

In the fourth step [B4] in FIG. 7, the dedicated application 4510 displays the product list data 7530 on the smartphone 2320 and receives an operation to select an EC process by the user 1200.

If the system is configured such that UI-processed scene image data, which is described in the previous section “EC-integrated meta media distribution process (second explanation)”, is sent to the smartphone 2320 instead of the product list data 7530, multiple sets of UI-processed scene image data are displayed as thumbnails as described above when the scene selection operation has been performed a plurality of times. Thereby it is possible to provide users with a more convenient way to select a product.

In this case, as to the scene image data that constitutes the multiple sets of UI-processed scene image data sent to the smartphone 2320, the scene image data of a video image distributed to the television cannot be acquired directly. However, corresponding scene image data (with a matching scene ID) can be acquired with reference to (by searching for) the video data distributed to the television in the video data management database 5230, where video data for the public is stored in the eighth step of the scene management data generation process described above (see (2) in FIG. 8), by using scene data (including a video ID and scene ID) that is retrieved through the process of searching for scene data based on the scene identification information 7410 sent to the main system 2200. Thus, as in the eighth step of the EC-integrated metamedia distribution process described above, multiple sets of UI-processed scene image data can be composed by performing UI processing on ranges in which products corresponding to the product list data 7530 contained in the acquired scene image data are displayed.

As described above, according to the second embodiment, it is possible to provide an e-commerce function that enables easy and direct purchase of products offered for sale in video content from its scenes without the need for a dedicated viewing system.

With this, EC-integrated video content can be distributed through TV broadcasting. For example, by simply pointing a smartphone at the EC-integrated video content being broadcast on the street, a user can obtain the scene image of the EC-integrated video content as if they have taken a screen capture. Furthermore, since this image can be provided as UI-processed scene image data, the user's impulsive attention is not distracted from products.

While certain embodiments have been illustrated and described herein, it is to be understood that the scope of the inventions is not limited to these specific embodiments. As would be apparent to those skilled in the art, the embodiments described herein may be embodied in a variety of other forms; furthermore, various changes, modifications, and alterations may be made without departing from the spirit and scope of the disclosure as defined by the appended claims.

What is claimed is:

1. A method for creating EC-integrated metamedia with a built-in user interface (UI) function for electronic commerce (EC) that allows users, viewers of video content, to trade a resource for producing the video content as a product, the method comprising the steps of:
[a] registering information on a product in a product data management database configured to manage product data;
[b] creating an EC product table to manage information related to EC processing of the product;
[c] creating an edit information sharing file to share information on editing the video content;
[d] creating a scene management file to manage scene information based on information related to scenes in the edit information sharing file and adding thereto a product ID of the product data management database;
[e] registering scene data of the scene management file in a scene data management database configured to manage scene data;
[f] registering video data of the video content for the public in a video data management database configured to manage video data; and
[g] generating trained data for object detection based on scenes in the video data for the public, the scene data in the scene data management database, and the product data in the product data management database.

2. The method according to claim 1, wherein the step [e] includes embedding an audio watermark in each scene of the video content.

3. A system for distributing EC-integrated metamedia with a built-in user interface (UI) function for electronic commerce (EC) that allows users, viewers of video content, to trade a resource for producing the video content as a product, the system comprising a processor configured to:
display the video content on a client device of a user;
detect a selection operation by the user to select a scene in the video content on the client device;
acquire scene related data from the client device, wherein the scene related data includes identification information for the scene and scene image data at a time of the selection operation;
detect an object in the scene image data;
retrieve product information based on the identification information;
check whether the detected object is included in the product information;
generate UI-processed scene image data with a link element in a range in which the object is displayed in the scene image data;
detect a call operation by the user to call the UI-processed scene image data on the client device;
detect a selection operation by the user to select the link element in the UI-processed scene image data, which has been sent to the client device and displayed thereon in response to the call operation, on the client device and acquire the selected link element from the client device;
retrieve product information corresponding to the link element and send the product information to the client device;
detect a selection operation by the user to select an EC process type for a product in the product information displayed on the client device and acquire the selected EC process type from the client device; and
call an EC process for the product based on the EC process type.

4. The system according to claim 3, wherein the EC process called includes a transaction process based on a smart contract.

5. A method for distributing EC-integrated metamedia with a built-in user interface (UI) function for electronic commerce (EC) that allows users, viewers of video content, to trade a resource for producing the video content as a product, the method comprising the steps of:
[a] displaying the video content on a client device of a user;
[b] detecting a selection operation by the user to select a scene in the video content on the client device;
[c] acquiring identification information for the scene and scene image data at a time of the selection operation from the client device;
[d] detecting an object in the scene image data;
[e] retrieving product information based on the identification information;
[f] checking whether the detected object is included in the product information;
[g] generating UI-processed scene image data with a link element in a range in which the object is displayed in the scene image data;
[h] detecting a call operation by the user to call the UI-processed scene image data on the client device;
[i] detecting a selection operation by the user to select the link element in the UI-processed scene image data, which has been sent to the client device and displayed thereon in response to the call operation, on the client device and acquiring the selected link element from the client device;
[j] retrieving product information corresponding to the link element and sending the product information to the client device;
[k] detecting a selection operation by the user to select an EC process type for a product in the product information displayed on the client device and acquiring the selected EC process type from the client device; and
[l] calling an EC process for the product based on the EC process type.

6. The method according to claim 5, further comprising storing the UI-processed scene image data displayed on the client device.

7. The method according to claim 5, further comprising, when the steps [b], [c], [d], [e], and [f] are performed a plurality of times while the video content is displayed on the client device, storing the UI-processed scene image data generated in the step [g] each time the steps are performed.

8. The method according to claim 7, wherein, when multiple sets of UI-processed scene image data are stored and sent to the client device, the UI-processed scene image data are displayed in thumbnail format on the client device.

9. The method according to claim 5, wherein the EC process for the product called based on the EC process type includes a smart contract between the user and a supplier of the product.

10. A method for distributing EC-integrated metamedia with a built-in user interface (UI) function for electronic commerce (EC) that allows users, viewers of video content, to trade a resource for producing the video content as a product, the method comprising the steps of:
[a] embedding an audio watermark in each scene of the video content as audio-encoded identification information;
[b] broadcasting the video content on a general-purpose viewing device:
[c] detecting a selection operation by the user to select a scene in the video content on a client device;
[d] acquiring identification information for the scene at a time of the selection operation from the client device;
[e] retrieving product information based on the identification information;
[f] sending the product information to the client device;
[g] displaying the product information on the client device;
[h] receiving an EC process performed by the user for a product in the product information displayed on the client device;
[i] referring to an EC process type of the product information in response to the EC process; and
[j] calling an EC process configuration corresponding to the EC process type.

11. The method according to claim 10, further comprising:
retrieving video data based on the identification information acquired in the step [d] and acquiring scene image data corresponding to the identification information from the video data;
generating UI-processed scene image data with a link element in a range in which the product in the product information retrieved in the step [e] is displayed in the scene image data;
sending the UI-processed scene image data to the client device instead of the product information in the step [f];
displaying the UI-processed scene image data on the client device instead of the product information in the step [g];
detecting a selection operation by the user to select the link element in the UI-processed scene image data on the client device and acquiring the selected link element from the client device prior to the step [h]; and
retrieving product information based on the link element and sending the product information to the client device such that the product information is displayed thereon.
